(19) United States
(12) Patent Application Publication
(10) Pub. No.: US 2004/0234927 A1
(43) Pub. Date: Nov. 25, 2004

(54) Artificial maxillary molar unit and alignment instrument to be used for aligning the artificial maxillary molar unit in denture

(76) Inventor: Shinji Hiraiwa, Nishikasugai-gun (JP)

Correspondence Address: BURR & BROWN, PO BOX 7068, SYRACUSE, NY, 13261-7068, US

(21) Appl. No.: 10/811,486

(22) Filed: Mar. 26, 2004

(30) Foreign Application Priority Data
Mar. 28, 2003 (JP) 2003-092182

(51) Int. Cl. A61C 13/12

(52) U.S. Cl. 433/180; 433/197

(57) ABSTRACT

An artificial maxillary molar unit which enables a user to bite through food without a pain, and an alignment instrument which facilitates to make a denture using the artificial maxillary molar unit are provided. The denture is made by using an artificial maxillary molar unit 6. An artificial maxillary molar has an occlusal surface on which a ridge 8 having a sharp edge is aligning along a line corresponding to a ridge of a cusp on an occlusal surface of a natural maxillary molar. The ridge of the occlusal surface of the artificial maxillary molar has opposite sides each formed as a concave surface 9 having a gentle inclination from the occlusal surface toward a root. During the making of the denture, an alignment instrument having one surface on which an impression corresponding to the occlusal surface of the artificial maxillary molar unit 6 is provided.

This application claims the benefit of Japanese Application No. 2003-092182, filed Mar. 28, 2003, the entirety of which is incorporated herein by reference.

### BACKGROUND OF THE INVENTION

1. Field of the Invention

The present invention relates to an artificial maxillary molar unit which works as a maxillary molar in an oral cavity and is used on a complete denture, a partial denture and the like, and also relates to an alignment instrument to be used for aligning the artificial maxillary molar unit on a denture.

2. Description of Related Art

Conventionally, the majority of artificial teeth used as molars have been formed in shapes which are designed to faithfully reproduce the shapes of natural teeth based on the concept that molars serve the function of grinding food. It is also known that popular artificial teeth make use of plastic materials. However, it has recently been found that molars also mainly serve the function of biting through food, and conventional artificial molars having occlusal surfaces formed as gently undulating surfaces cannot be expected to serve the function of biting through food. This is because in the case where artificial teeth are used as a complete denture or a partial denture, such a denture is only placed on brittle gingiva and the resultant mastication pressure is overwhelmingly small compared to natural teeth. Accordingly, with the conventional artificial teeth whose occlusal surfaces are gently undulating surfaces, it is impossible to bite through or crush hard food and fibrous food.

Artificial teeth made of plastic also have the disadvantage that parts such as cusps and ridges are easily abraded and a long time continuous use causes problem for user to bite through food.

To resolve these problems, the artificial tooth disclosed in JP-A-2002-306511 has been conceived for a purpose of restraining the abrasion of an artificial tooth and, at the same time, improving the mastication function thereof. This artificial tooth has a construction in which abrasion-resistant wire is partially exposed from its flat occlusal surface. The artificial tooth aims to catch and bite through food with the exposed wire.

A metal-made artificial tooth is also used which is called a blade metal tooth as disclosed JP-A-55-106146. As shown in FIG. 11, a blade metal tooth 80 has a shape in which thin semicircular plates 81 are uprightly disposed so that their diameters cross each other at right angles. The part at which two semicircular plates 81 cross each other is used as a cusp 82 so that a user can bite through food.

However, the wired artificial tooth disclosed in JP-A-2002-306511 is actually incapable of sticking into food, and if a user uses the wired artificial tooth as a denture whose mastication pressure is weak compared to natural teeth, the user will still find it difficult to bite through food.

The blade metal tooth 80 disclosed in JP-A-55-106146 has concave and convex shapes opposite to those of a natural tooth and is formed in a shape raised in the center. Accordingly, during lateral movements toward the right and the left, the convex portions of opposed upper and lower teeth easily tend to come into contact with each other and cause an overturn of the denture. As a result, the tongue and cheek mucosa of the user are injured, which hinders the user from performing mastication movements. Furthermore, since the semicircular plates 81 are uprightly disposed like walls, when the user bites food, the food is stopped and moved back at the horizontal plane of the basal part of an SA artificial tooth. Therefore, the user finds it difficult to pass food into the oral cavity, that is, to perform smooth mastication movements while biting and cutting through the food.

In a conventional complete denture which is made of the blade metal tooth 80, the second premolar, the first molar and the second molar are replaced with the blade metal teeth 80, 80, . . . respectively. Namely, the first molar is a conventional artificial tooth made of plastic, but since a human tries to bite through food with his maxillary canine teeth and the lower-side cusps of his maxillary first premolars, the human cannot smoothly bite through food with the form of the existing artificial first molar.

During making a denture, a dental technician aligns artificial molars on the denture one by one on the basis of his experience, with reference to a model or a radiograph of the oral cavity of a patient. As a result, the degrees of completion of dentures depend on the capabilities of individual dental technicians, and as a matter of course, individual dentures have different degrees of completion. In addition, wax which forms a base undergoes a shrinkage due to drying, and strain occurs in polymerized wax. For this reason, the process of correcting strain by cutting an installed artificial tooth to a further extent is carried out. As a matter of course, since the artificial tooth is forcedly cut and its occlusal surface becomes flat, it is difficult for such a denture to serve the desired function.

### SUMMARY OF THE INVENTION

Therefore, the invention aims to provide an artificial maxillary molar unit which is capable of biting through food even with a weak mastication pressure and which gives consideration to the anatomical shape of a natural tooth so that its mastication movement agrees with human mastication movement.

The invention also provides an alignment instrument for making a far more precise denture by facilitating the process of making a denture.

To achieve the above and other objects, an artificial maxillary molar unit according to a first aspect of the invention includes an artificial maxillary molar constructed to work as a maxillary molar in an oral cavity, and the artificial maxillary molar includes an occlusal surface on which a ridge having a sharp edge is aligning along a line corresponding to a ridge of a cusp on an occlusal surface of a natural maxillary molar, and the ridge of the occlusal surface of the artificial maxillary molar has opposite sides each formed as a concave surface having an inclination which is made gradually gentler from the occlusal surface toward a root.

In an artificial maxillary molar unit according to a second aspect, in addition to the object described in the first aspect, a cheek-side surface and a tongue-side surface of the artificial maxillary molar are chamfered so that a cheek and a tongue are not injured.

In an artificial maxillary molar unit according to a third aspect, in addition to the objects described in the first or second aspect, a plurality of adjacent artificial maxillary molars are integrally or connectably formed so that, for example, a denture making process is made far easier.

In an artificial maxillary molar unit according to a fourth aspect, in addition to the objects described in any of the first to third aspects, a hollow is provided on a reverse side of the artificial maxillary molar so that the artificial maxillary molar unit can be used as, for example, a magnetic attachment or an implant.

According to a fifth aspect, in an alignment instrument to be used for making a denture by using an artificial maxillary molar unit as described in the first aspect, an impression corresponding to an occlusal surface of an artificial maxillary molar unit is provided on one surface of the alignment instrument.

According to a sixth aspect, in an alignment instrument to be used for making a complete denture by using an artificial maxillary molar unit as described in the first aspect, an impression corresponding to an occlusal surface of an artificial maxillary molar unit and an impression corresponding to an occlusal surface of a mandibular molar are respectively provided on opposite surfaces of the alignment instrument in an occluding state.

### BRIEF DESCRIPTION OF THE DRAWINGS

The invention will become more readily appreciated and understood from the following detailed description of a preferred embodiment of the invention when taken in conjunction with the accompanying drawings.

FIG. 1 is a perspective view showing the state in which an integrated artificial maxillary molar unit is installed in a maxillary complete denture.

FIG. 2 is a plan view showing the state in which the integrated artificial maxillary molar unit is installed in the maxillary complete denture.

FIG. 3 is a cross-sectional view taken along line A-A of FIG. 1.

FIG. 4 is a cross-sectional view taken along line B-B of FIG. 1.

FIG. 5 is an occlusion diagram of the denture using the artificial maxillary molar unit.

FIGS. 6A and 6B are plan views of an alignment instrument.

FIG. 7 is a view showing a state in which the complete denture is being made by using a making instrument.

FIG. 8 is a view showing a state in which the complete denture is being made by using the alignment instrument.

FIG. 9 is a view showing a state in which the complete denture is being made by using the alignment instrument.

FIG. 10 is a cross-sectional view of an artificial maxillary molar provided with a hollow.

FIG. 11 is a view showing a conventional denture.

### DETAILED DESCRIPTION OF THE INVENTION

An integrated artificial maxillary molar unit in which four maxillary molars are integrally formed according to one embodiment of the invention will be described below with reference to the accompanying drawings.

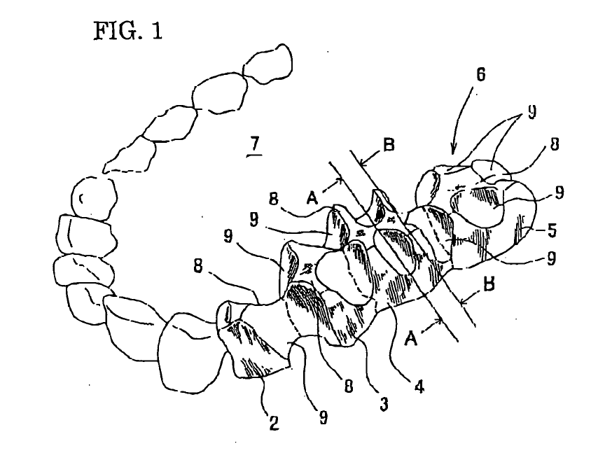

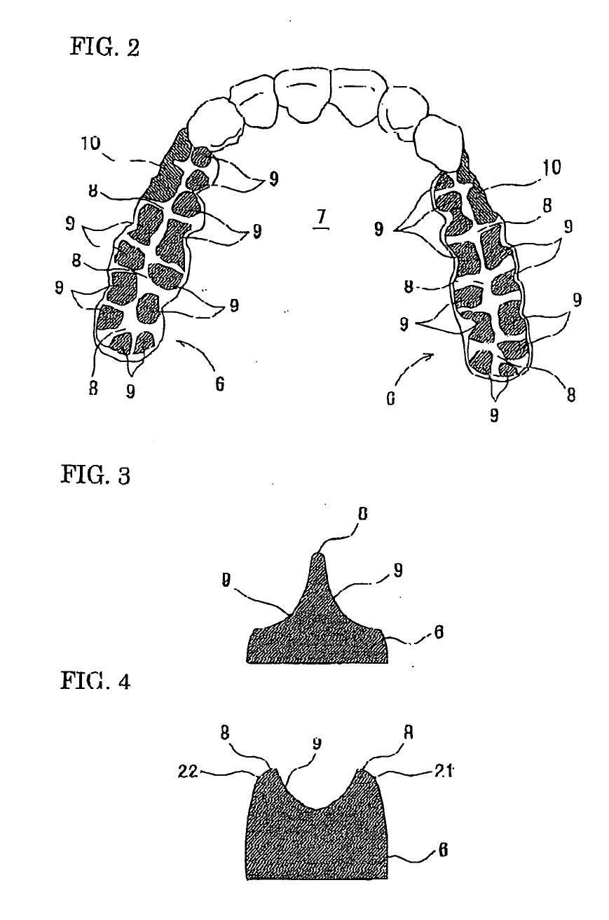

FIG. 1 is a perspective view showing the state in which an integrated artificial maxillary molar unit 6 is installed in a maxillary complete denture 7, and the integrated artificial maxillary molar unit 6 includes in an integrated form an artificial first premolar 2, an artificial second premolar 3, an artificial first molar 4, and an artificial second molar 5 all of which are to be applied to the upper jaw. FIG. 2 is a plan view showing the state in which the integrated artificial maxillary molar unit 6 is installed in the maxillary complete denture 7. FIG. 3 is a cross-sectional view taken along line A-A, showing the maxillary artificial first molar 4.

All of these artificial maxillary molars are made of a titanium-base material which excels in properties such as abrasion resistance and durability, and the dimensions, such as width, height and length, of each of the artificial maxillary molars are selected to be average sizes of natural molars.

The form of the artificial first molar 4 (the second molar numbered from the back side of the integrated artificial maxillary molar unit 6) will be described below. On the occlusal surface of the artificial first molar 4, a line corresponding to the ridge of a cusp on the occlusal surface of a natural first molar is formed as a ridge 8, and the edge of the ridge 8 is sharpened like an ax. In addition, as shown in FIG. 2, concave surfaces 9 each having an inclination which is made gradually gentler from the ridge 8 toward the root of the artificial first molar 4 are formed to spread in various directions. Namely, the occlusal surface of the artificial first molar 4 is not formed as a gentle undulating surface like the occlusal surface of a natural molar, and is shaped so that the concave surfaces 9 each having an eroded shape are formed on the portions (in FIG. 2, hatched portions) of the occlusal surface that exclude the ridge 8.

FIG. 3 is a cross-sectional view taken along line A-A, showing the artificial first molar 4, and FIG. 4 is a cross-sectional view taken along line B-B, showing the artificial first molar 4.

As shown in FIG. 3, the angle of the sharp edge of the ridge 8 is made 100-110 degrees with respect to the horizontal of the occlusal surface so that the sharp edge gains an angle suited for biting through food. In addition, as shown in FIG. 4, since the ridge 8 is formed to correspond to the ridge of a cusp on the occlusal surface of a natural molar, the artificial first molar 4 has a shape concave in the center similarly to a natural molar. Furthermore, each of a cheek-side surface 21 and a tongue-side surface 22 of the artificial first molar 4 is chamfered to have a round shape.

Each of artificial first premolar 2, the artificial second premolar 3, and the artificial second molar 5 is also formed similarly to the artificial first molar 4; that is to say, a ridge having a sharp edge is formed on the occlusal surface in such a manner as to extend along a line corresponding to the ridge of a cusp on the occlusal surface of the corresponding natural molar, and the opposite sides of the ridge are respectively formed as concave surfaces each having an inclination which is made gradually gentler from the occlusal surface toward the root.

However, cheek-side surface 10 of the artificial first premolar 2 is cut off (refer to FIG. 2). During the making of the maxillary complete denture, this cut-off portion is filled with a plastic material like a natural molar.

The integrated artificial maxillary molar unit 6 includes the artificial first premolar 2, the artificial second premolar 3, the artificial first molar 4, and the artificial second molar 5 in the integrated form. In this construction, the ridges of the artificial molars which mutually adjacent are contiguously formed to constitute one ridge. The concave surfaces are also formed in a similar manner so that the concave surfaces of the artificial molars which mutually adjacent are contiguously formed to constitute one gently undulating surface.

When the maxillary complete denture 7 in which the integrated artificial maxillary molar unit 6 formed in this manner is installed, a user can easily bite through food even with a weak mastication pressure because the ridges 8 each having a sharp edge are contiguously formed on the occlusal surface of the integrated artificial maxillary molar unit 6. Accordingly, the maxillary complete denture 7 becomes stable, so that it is possible to minimize pain which the user may suffer during mastication movements. In addition, when the user bites food, the food can be smoothly cut through and carried into the oral cavity of the user along the concave surfaces 9 without remaining because the concave surfaces 9 are in a round shape. Accordingly, the user can more comfortably masticate.

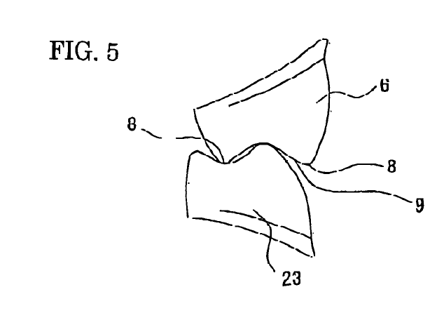

In addition, because the ridge 8 is a line corresponding to the ridge of a cusp on the occlusal surface of a natural molar, the tongue-side cusp of the maxillary molar appropriately engages with the central depression of a mandibular molar 23 as shown in FIG. 5 after food is cut through in such a way that the ridge of a maxillary molar and the ridge of a mandibular molar rub against each other. Namely, since it is possible to realize the same mastication movements as natural mastication movements, the denture is stabilized. Accordingly, it can be prevented a large burden on the gingiva of the user of the denture, thereby minimizing pain which the user may suffer during mastication.

Furthermore, the cheek side and the tongue side of the integrated artificial maxillary molar unit 6 have round forms, respectively, so that user's tongue and cheek mucosa are prevented from being injured.

In addition, since the four molars are integrally formed, even if only a necessary molar is selectively used from among the four molars, the remaining molars can be reserved, and can also be used when molars corresponding to the remaining molars are damaged on a later day.

Yet further, since the four molars are integrally formed, there are no gaps between the molars. Accordingly, dirt is rarely stored in such gaps, whereby the artificial maxillary molar unit 6 can be easily kept clean.

In addition, the cheek-side part of the artificial first premolar 2 is formed from a plastic molar which is modeled after a natural tooth, whereby it is possible to prevent the inside of the oral cavity from being deteriorated in appearance when such an artificial molar is in use. In addition, even if the integrated artificial maxillary molar unit 6 is processed in this manner, it does not seriously affect in biting through food.

An embodiment of an alignment instrument to be used for aligning artificial molars constructed in the above-described manner on a maxillary complete denture, as well as a method of using such alignment instrument will be described below.

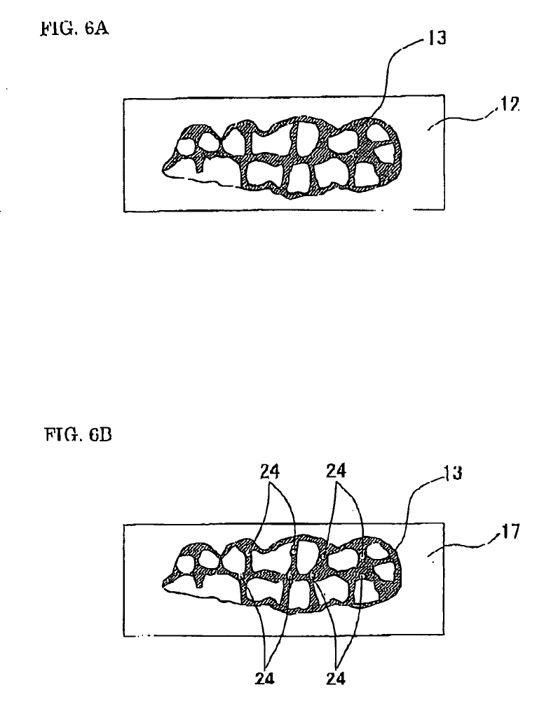

FIG. 6A is a view showing the obverse surface of a first alignment instrument 12 to be used for making a maxillary complete denture 14, and FIG. 6B is a view showing the reverse surface of a second alignment instrument 17 to be used for making a mandibular complete denture 15 corresponding to the maxillary complete denture 14.

Each of the first alignment instrument 12 and the second alignment instrument 17 has a thin plate-like shape, and is formed of an elastic material such as silicone rubber.

An impression 13 for the occlusal surface of the integrated artificial maxillary molar unit 6 is provided on the obverse surface of the first alignment instrument 12, and the reverse surface of the first alignment instrument 12 is formed as a flat surface.

An impression 13 for the occlusal surface of the integrated artificial maxillary molar unit 6 is provided on the obverse surface of the second alignment instrument 17, and an impression 16 for the occlusal surfaces of artificial mandibular molars 20 of the mandibular complete denture 15 corresponding to the maxillary complete denture 14 is provided on the reverse surface of the second alignment instrument 17 (refer to FIG. 9). Accordingly, the second alignment instrument 17 has a form in which holes 24 are opened in a portion where maxillary molars and mandibular molars come into contact with one another.

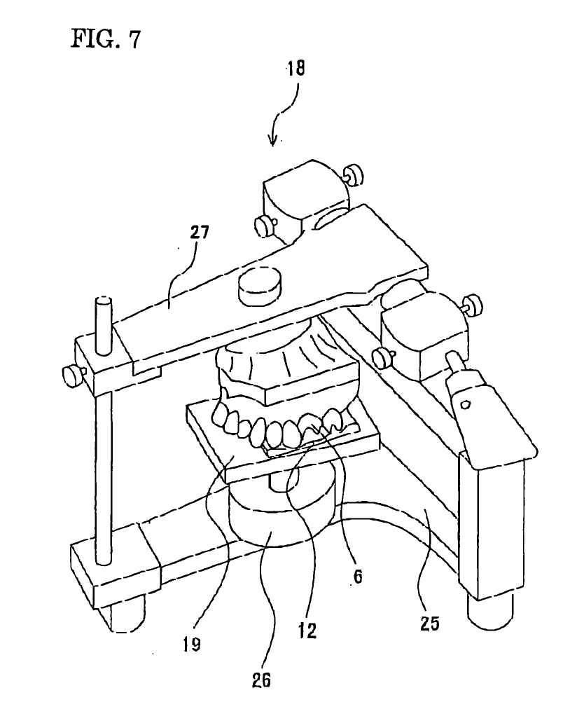

A method of using the first alignment instrument 12 and the second alignment instrument 17 during the making of a complete denture will be described below with reference to FIGS. 7, 8 and 9.

During the process of making a complete denture, a making instrument 18 is used which includes a base 25, a support 26 secured to the base 25, an occlusal plate 19 disposed on the support 26, and a movable part 27 capable of reproducing the opening and closing movements of jaws.

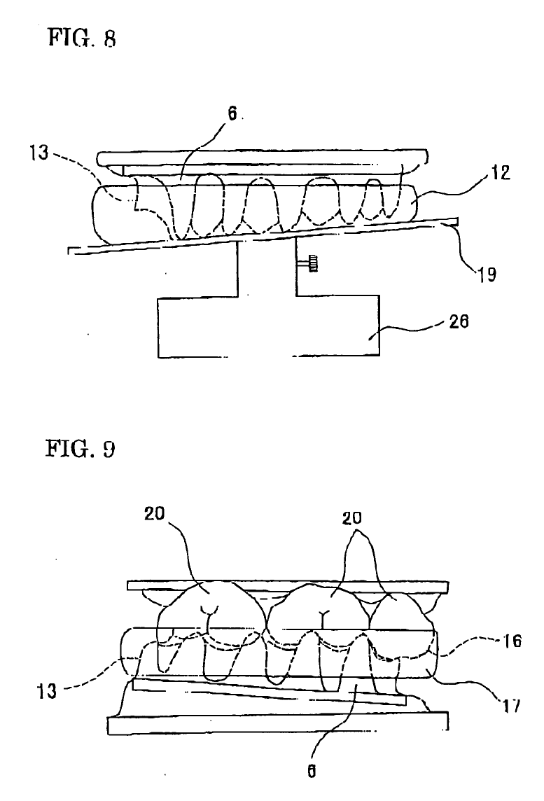

First of all, the occlusal plate 19 provided in the making instrument 18 is adjusted to coincide with the occlusal plane of a complete-denture user, and the maxillary complete denture 14 is fitted in the making instrument 18. Then, as shown in FIG. 8, a combination in which the integrated artificial maxillary molar unit 6 is engaged with the impression 13 provided on the obverse surface of the first alignment instrument 12 is installed on the occlusal plate 19, and the integrated artificial maxillary molar unit 6 is adjusted together with the first alignment instrument 12 so that the integrated artificial maxillary molar unit 6 and the maxillary complete denture 14 relatively assume a predetermined positional relationship. Then, the gap between the integrated artificial maxillary molar unit 6 and the maxillary complete denture 14 is filled with wax.

Then, as shown in FIG. 9, the maxillary complete denture 14 is turned upside down and the occlusal plate 19 is removed. Then, the first alignment instrument 12 is removed, and the surface of the second alignment instrument 17 on which the impression 13 is provided is brought into engagement with the integrated artificial maxillary molar unit 6. Furthermore, the artificial mandibular molars 20 are brought into engagement with the impression 16 for the occlusal surfaces of the artificial mandibular molars 20 that is provided on the second alignment instrument 17.

The mandibular complete denture 15 is secured to the movable part 27 of the making instrument 18 and is fitted with the maxillary complete denture 14, and the gap between the artificial mandibular molars 20 and the mandibular complete denture 15 is filled with wax to finish the complete denture.

As compared with the method of aligning artificial molars one by one, in the complete denture made in the above-described manner, the artificial molars are joined together by the use of the first alignment instrument 12, so that the relative positional relationship between the teeth does not easily deviate. In addition, the occlusal plane can be easily formed horizontally. Furthermore, since the artificial molars are made to bite the alignment instrument, the position of the artificial molars does not deviate even if wax dries and shrinks. Accordingly, it is possible to make a highly precise maxillary complete denture more easily.

Yet further, by the use of the second alignment instrument 17, it is possible to determine the position of the lower jaw with respect to the upper jaw very easily, and it is possible to make complete dentures which enable the upper and lower jaws to fit together excellently.

It should be noted that the above-described embodiment of the invention is applied to an integrated artificial maxillary molar unit including four molars formed in an integrated form, but the invention is not at all limited to this embodiment.

For example, instead of integrally forming four molars, it is also possible to integrally form three adjacent molars or two adjacent molars. Furthermore, even one molar can fully work. In addition, although a part of a complete denture is formed in the embodiment, the artificial maxillary molar can be solely used as a partial denture.

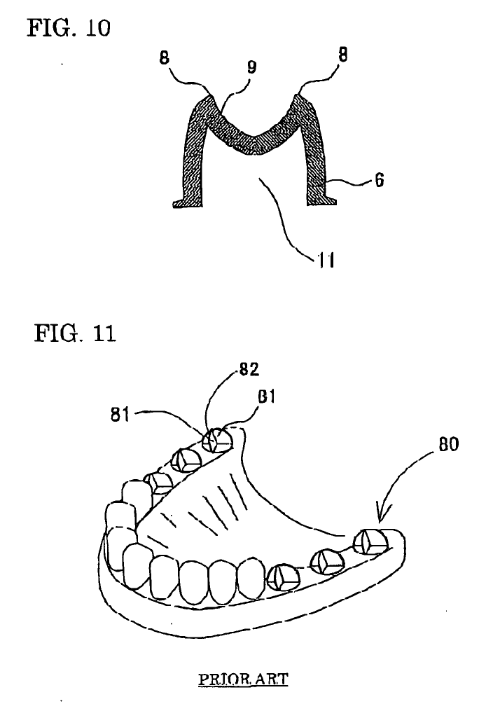

Furthermore, as shown in FIG. 10, a hollow 11 may be provided on the reverse side of an artificial maxillary molar so that the artificial maxillary molar can be used as a magnetic attachment,.an implant or the like.

Yet further, as the material of the artificial maxillary molar, a metal such as a titanium-base metal, a platinum-added gold alloy or a cobalt-chromium-base metal, hard plastic or the like may also be used instead of the titanium-base material. In addition, even in the case where a mandibular molar opposite to the artificial maxillary molar is a natural tooth, it is possible to use the artificial maxillary molar without the risk of injuring the natural teeth, by using hard plastic or a soft metal such as a platinum-added gold alloy.

In addition, in the embodiment, the cheek-side part 10 of the artificial first premolar is covered with a plastic molar which is modeled after a natural tooth, but even if the cheek-side part 10 is not cut, the artificial first premolar having the ridge and the concave surfaces can be used without any problem.

Furthermore, it may be possible to provide a stick-shaped maintaining part on the reverse surface of the integrated artificial maxillary molar unit so that the integrated artificial maxillary molar unit can be prevented from coming off during the installation of the integrated artificial maxillary molar unit in the maxillary complete denture.

In the embodiment, the alignment instrument is used during the making of a complete denture, but as a matter of course, the alignment instrument can also be used for the making of a partial denture. Furthermore, although the alignment instrument is provided with the impression corresponding to the artificial molar unit in which four teeth are integrally formed, the alignment instrument may also be provided with an impression corresponding to an artificial molar unit in which three teeth are integrally formed or two teeth are integrally formed, or can be even provided with an impression corresponding to a single artificial molar without any problem.

In addition, the material of the alignment instrument needs only to be an elastic material, and is not at all limited to silicone rubber. The alignment instrument may also have a block-like shape instead of a plate-like shape. Namely, the alignment instrument can, with no problem, have any shape that is thick enough to allow an impression to be provided on the alignment instrument.

According to a first aspect of the invention, since a ridge having a sharp edge is formed on the occlusal surface of each artificial maxillary molar of the artificial maxillary molar unit, a user can easily bite through food even with a weak mastication pressure. In addition, the ridge has opposite sides each formed as a concave surface having an inclination which is made gradually gentler in the downward direction, so that when the user bites food, the food is cut through along the concave surfaces and carried into the oral cavity. Accordingly, the user can more easily bite through the food. Furthermore, the ridge is formed to align corresponding to the ridge of a cusp on the occlusal surface of a natural maxillary molar, so that the artificial maxillary molar can excellently meet with a mandibular molar.

According to a second aspect of the invention, in addition to the advantages described in the first aspect, there is little risk of injuring the inside of the oral cavity such as a cheek mucosa or a tongue.

According to a third aspect of the invention, since artificial maxillary molars are formed in an integrated or connected state, the relative positional relationship between the molars can be kept desirably during the making of a denture, which enables to make a highly precise denture having a horizontal occlusal plane more easily. In addition, since there are no gaps between the molars, dirt is rarely stored, whereby the artificial maxillary molar unit can be easily kept clean.

According to a fourth aspect of the invention, since a hollow is provided on a reverse side of the artificial maxillary molar, the artificial maxillary molar can be used as, for example, a magnetic attachment or an implant.

According to a fifth aspect of the invention, during the making of a denture by using the artificial maxillary molar unit described in any of the first to fourth aspects, the denture can be made by engaging the artificial maxillary molar unit with an impression, which is provided on one surface of an alignment instrument, corresponding to the occlusal surface of the artificial maxillary molar. Accordingly, it is possible to prevent the artificial maxillary molar unit from deviating owing to drying, shrinkage or the like of a base.

According to a sixth aspect of the invention, during the making of a complete denture by using the artificial maxillary molar unit described in any of the first to fourth aspects, since an impression corresponding to the occlusal surface of the artificial maxillary molar unit and an impression corresponding to the occlusal surface of a mandibular molar are respectively provided on opposite surfaces of the alignment instrument in an occluding state, the position of the lower jaw with respect to the upper jaw can be easily determined. Further, it is possible to make a complete denture which enables the upper and lower jaws to meet together excellently.

What is claimed is:

1. An artificial maxillary molar unit comprising an artificial maxillary molar constructed to work as a maxillary molar in an oral cavity,
wherein the artificial maxillary molar includes an occlusal surface on which a ridge having a sharp edge is aligning along a line corresponding to a ridge of a cusp on an occlusal surface of a natural maxillary molar, and the ridge of the occlusal surface of the artificial maxillary molar has opposite sides each formed as a concave surface having an inclination which is made gradually gentler from the occlusal surface toward a root.

2. An artificial maxillary molar unit according to claim 1, wherein a cheek-side surface and a tongue-side surface of the artificial maxillary molar are chamfered.

3. An artificial maxillary molar unit according to claim 1, wherein a plurality of adjacent artificial maxillary molars are integrally or connectably formed.

4. An artificial maxillary molar unit according to claim 2, wherein a plurality of adjacent artificial maxillary molars are integrally or connectably formed.

5. An artificial maxillary molar unit according to claim 1, wherein a hollow is provided on a reverse side of the artificial maxillary molar.

6. An artificial maxillary molar unit according to claim 2, wherein a hollow is provided on a reverse side of the artificial maxillary molar.

7. An artificial maxillary molar unit according to claim 3, wherein a hollow is provided on a reverse side of the artificial maxillary molar.

8. An artificial maxillary molar unit according to claim 4, wherein a hollow is provided on a reverse side of the artificial maxillary molar.

9. An alignment instrument to be used for making a denture by using an artificial maxillary molar unit according to claim 1, wherein an impression corresponding to an occlusal surface of an artificial maxillary molar unit is provided on one surface of the alignment instrument.

10. An alignment instrument to be used for making a complete denture by using an artificial maxillary molar unit according to claim 1, wherein an impression corresponding to an occlusal surface of an artificial maxillary molar unit and an impression corresponding to an occlusal surface of a mandibular molar are respectively provided on opposite surfaces of the alignment instrument in an occluding state.
